(19) United States
(12) Patent Application Publication
(10) Pub. No.: US 2016/0004976 A1
(43) Pub. Date: Jan. 7, 2016

(54) SYSTEM AND METHODS FOR ABDUCTIVE LEARNING OF QUANTIZED STOCHASTIC PROCESSES

(71) Applicant: CORNELL UNIVERSITY, Ithaca, NY (US)

(72) Inventors: Ishanu Chattopadhyay, Ithaca, NY (US); Hod Lipson, Ithaca, NY (US)

(21) Appl. No.: 14/775,856

(22) PCT Filed: Mar. 14, 2014
(86) PCT No.: PCT/US14/29333

§ 371 Date: Sep. 14, 2015

Related U.S. Application Data
(60) Provisional application No. 61/791,171, filed on Mar. 15, 2013.

(51) Int. Cl. G06N 7/00

(52) U.S. Cl. CPC G06N 7/005

(57) ABSTRACT

A device for inferring a probabilistic finite state automation is described. The device that may infer a probabilistic finite state automation from an observed trace. A device may include a computing device configured to infer a probabilistic finite state automation in order to predict the distribution of future symbols based on the recent past. Devices described herein may be useful in analyzing one or more of the following: probability of errors in signal transmission, flow of wealth in the stock market, geophysical phenomena (e.g., climate changes and seismic events, such as, earthquakes), ecology of evolving ecosystems (e.g., populations), genetic regulatory circuits and even social interaction dynamics (e.g., traffic patterns).

This application claims the benefit of U.S. Provisional Application No. 61/791,171, filed on Mar. 15, 2013, which is incorporated by reference in its entirety.

### GOVERNMENT SUPPORT

This invention was made with government support under grant ECCS 09141561 awarded by NSF CDI. This invention was made with government support under grant HDTRA 1-09-1-0013 awarded by DTRA. The government has certain rights in the invention.

### TECHNICAL FIELD

This disclosure relates to systems and methods for analyzing stochastic processes and more particularly to providing a device that may infer a probabilistic finite state automation.

### BACKGROUND

Stochastic processes are random processes. The output of which may be quantized and represented using an alphabet of symbols. For example, the outcome of a coin flip may be represented by a binary “1” for heads and a binary “0” for tails. A trace, which, in some examples, may be referred to as a word or a sentence, may be used to represent multiple occurrences of a stochastic process. For example, five observed coin flips may be represented as “10011.” Further, stochastic processes may be dynamic and the probability of a particular outcome may change over time and/or based on past outcomes. That is, the probability of an outcome may be based on history (e.g., probability a temperature will increase after a number of previous consecutive days having a temperature increase). Systems with such stochastic dynamics and complex causal structures are of emerging interest, e.g. flow of wealth in the stock market, geophysical phenomena, ecology of evolving ecosystems, genetic regulatory circuits and even social interaction dynamics.

Dynamic stochastic processes may be described using a probabilistic finite state automatic, where a probabilistic finite state automatic may include a number of states, a number of letters in an alphabet, a state transition function, arc probabilities, and an initial state). Current techniques for inferring dynamic stochastic processes may be less than ideal. Current techniques may be computationally inefficient and may not properly infer the gradient of dynamic stochastic processes.

### SUMMARY

In general, this disclosure describes techniques for analyzing stochastic processes. In particular, the techniques described herein may be used to infer a probabilistic finite state automation. In one example, this disclosure describes a device that may infer a probabilistic finite state automation from an observed trace. In one example, a device such as a computing device, may be configured to infer a probabilistic finite state automation in order to predict the distribution of future symbols based on the recent past. Devices implementing the techniques described herein may be useful in analyzing one or more of the following: probability of errors in signal transmission, flow of wealth in the stock market, geophysical phenomena (e.g., climate changes and seismic events, such as, earthquakes), ecology of evolving ecosystems (e.g., populations), genetic regulatory circuits and even social interaction dynamics (e.g., traffic patterns).

According to one example of the disclosure, a method for inferring a probabilistic finite state automation, comprises receiving an observed string generated by a quantized stochastic process, constructing a derivative heap using the observed string, identifying a string mapping to a vertex of a convex hull of the derivative heap, detecting a structure of a transition function for an inferred probabilistic finite state automation associated with the identified string, and determining arc probabilities for the inferred probabilistic finite state automation associated with the identified string.

According to another example of the disclosure a device for inferring a probabilistic finite state automation, comprises one or more processors configured to receive an observed string generated by a quantized stochastic process, construct a derivative heap using the observed string, identify a string mapping to a vertex of a convex hull of the derivative heap, detect a structure of a transition function for an inferred probabilistic finite state automation associated with the identified string, and determine arc probabilities for the inferred probabilistic finite state automation associated with the identified string.

According to another example of the disclosure a non-transitory computer-readable storage medium has instructions stored thereon that upon execution cause one or more processors of a device to receive an observed string generated by a quantized stochastic process, construct a derivative heap using the observed string, identify a string mapping to a vertex of a convex hull of the derivative heap, detect a structure of a transition function for an inferred probabilistic finite state automation associated with the identified string, and determine arc probabilities for the inferred probabilistic finite state automation associated with the identified string.

According to another example of the disclosure an apparatus for inferring a probabilistic finite state automation comprises means for receiving an observed string generated by a quantized stochastic process, means for constructing a derivative heap using the observed string, means for identifying a string mapping to a vertex of a convex hull of the derivative heap, means for detecting a structure of a transition function for an inferred probabilistic finite state automation associated with the identified string, and means for determining arc probabilities for the inferred probabilistic finite state automation associated with the identified string.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is conceptual diagram illustrating an example of a random walk quantized stochastic process.

FIG. 1B is a conceptual diagram illustrating an example one-state probabilistic automation associated with the example random walk quantized stochastic process illustrated in FIG. 1A.

FIG. 1C is a graph illustrating an example observed traces associated with the example random walk quantized stochastic process illustrated in FIG. 1A.

FIG. 2 is a conceptual diagram illustrating an example of a long-range dependencies.

FIG. 3 is a block diagram illustrating an example of a computing device that may implement one or more techniques of this disclosure.

FIG. 4 is a conceptual diagram illustrating an example of canonical representations.

FIG. 5 is a conceptual diagram illustrating the concept of knowledge of initial states.

FIG. 6 is a conceptual diagram illustrating PFSAs, derivative heaps, and e-synchronizing strings.

FIG. 7 is a conceptual diagram comparing the techniques described herein to other techniques.

FIG. 8 is a conceptual diagram illustrating example techniques described herein applied to simulated data.

FIG. 9 is a conceptual diagram illustrating the techniques described herein compared to other techniques.

FIG. 10 is a conceptual diagram illustrating the techniques described herein compared to other techniques.

FIG. 11 is a conceptual diagram illustrating the techniques described herein compared to other techniques.

FIG. 12 is a conceptual diagram illustrating an example of inferring a probabilistic finite state automation according to the techniques described herein.

### DETAILED DESCRIPTION

Automated model inference is a topic of wide interest, and reported techniques for automated model inference range from query-based concept learning in artificial intelligence to classical system identification, to more recent symbolic regression based reverse-engineering of nonlinear dynamics. This disclosure describes techniques for inferring the dynamical structure of quantized stochastic processes (QSPs), e.g., stochastic dynamical systems evolving over discrete time, and producing quantized time series.

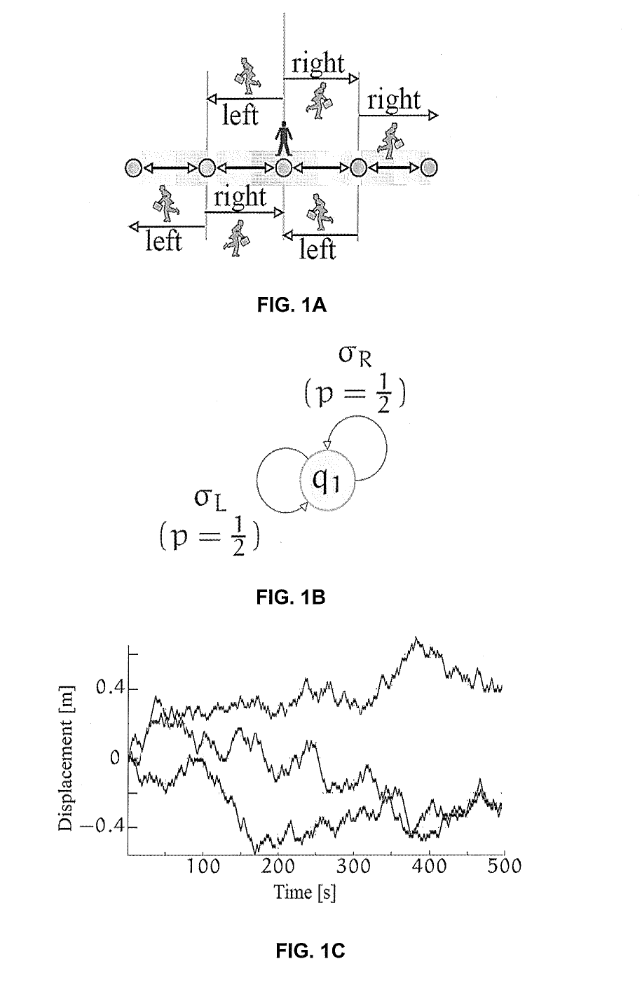

A simple example of a quantized stochastic process is the standard random walk on the line system. FIG. 1A is conceptual diagram illustrating an example of a random walk quantized stochastic process. In the example illustrated in FIG. 1A, constant positive and negative increments are represented symbolically as σR and σL, respectively, leading to a stochastic dynamical system that generates strings over the alphabet Σ, {σL, σR}, with each new symbol being generated independently with a probability of 0.5. The dynamical characteristics of the process illustrated in FIG. 1A are captured by the probabilistic automaton shown in FIG. 1B. FIG. 1B is a conceptual diagram illustrating an example one-state probabilistic automation associated with the example random walk quantized stochastic process illustrated in FIG. 1A.

As illustrated in FIG. 1B, the example random walk quantized stochastic process may be described using a probabilistic finite state automation including a single state q1, and self-loops labelled with symbols from the alphabet Σ, which represent probabilistic transitions. FIG. 1C is a graph illustrating an example observed traces associated with the example random walk quantized stochastic process illustrated in FIG. 1A. As illustrated in FIG. 1C, a trace resulting from an example random walk quantized stochastic process may be represented as a distance from a center at a point in time.

The techniques described herein may include unsupervised learning algorithms to infer the causal structure of quantized stochastic processes, defined as stochastic dynamical systems evolving over discrete time, and producing quantized observations. The techniques described herein may infer models that are generative, i.e., predict the distribution of the future symbols from knowledge of the recent past. Causal structures may formally be known as probabilistic finite state automaton (PFSA) and the techniques described herein may infer a PFSA from a sufficiently long sequence of observed symbols, with no a priori knowledge of the number, connectivity and the transition rules of the hidden states.

In some examples, the techniques described herein assume ergodicity and stationarity and infer probabilistic finite state automata models from a sufficiently long observed trace. Further, the techniques described herein may be abductive; attempting to infer a simple hypothesis, consistent with observations and modelling framework that essentially fixes the hypothesis class. In some examples, the probabilistic automata that is inferred have no initial and terminal states, have no structural restrictions and are shown to be probably approximately correct-learnable.

In some examples the techniques described herein use symbolic representation of data and quantize relative changes between successive physical observations to map the gradient of continuous time series to symbolic sequences (with each symbol representing a specific increment range). It should be noted that in some instances using a symbolic approach may cause information loss due to quantization. However, advantages of a symbolic approach may include unsupervised inference, computational efficiency, deeper insight into the hidden causal structures, ability to deduce rigorous performance guarantees and the ability to better predict stochastic evolution dictated by many hidden variables interacting in a structured fashion.

In some examples, the modelling framework described herein assumes that, at any given instant, a QSP is in a unique hidden causal state, which has a well-defined probability of generating the next quantized observation. This fixes the rule (i.e. the hypothesis class) by which sequential observations are generated, and the techniques described herein seek the correct hypothesis, i.e., the automaton that explains the observed trace. Inferring the hypothesis, given the observations and the generating rule is abduction (as opposed to induction, which infers generating rules from a knowledge of the hypothesis, and the observation set).

It should be noted that learning from symbolic data is essentially grammatical inference; learning an unknown formal language from a presentation of a finite set of example sentences. In the case of the techniques described herein, every subsequence of the observed trace is an example sentence. Inference of probabilistic automata is well studied in the context of pattern recognition.

However, learning dynamical systems with PFSA has received less attention, and the following issues have been observed: (1) Initial and terminal conditions: Dynamical systems evolve over time, and are often termination-free. Thus, inferred machines should lack terminal states. Reported algorithms often learn probabilistic automata with initial and final states, and with special termination symbols. (2) Structural restrictions: Reported techniques make restrictive structural assumptions, and pre-specify upper bounds on inferred model size. For example, some techniques infer only probabilistic suffix automata, and some techniques further require synchronizability, i.e., the property by which a bounded history is sufficient to uniquely determine the current state, and some techniques further restrict models to be acyclic and aperiodic. (3) Restriction to short memory processes: Often memory bounds are pre-specified as bounds on the order of the underlying Markov chain, or synchronizability; thus only learning processes with short range dependencies. A time series possesses long-range dependencies (LRDs), if it has correlations persisting over all time scales. In such processes, the auto-correlation function follows a power law, as opposed to an exponential decay. Such processes are of emerging interest, e.g. internet traffic, financial systems and biological systems. In some examples, the techniques described herein may be used to learn LRDs.

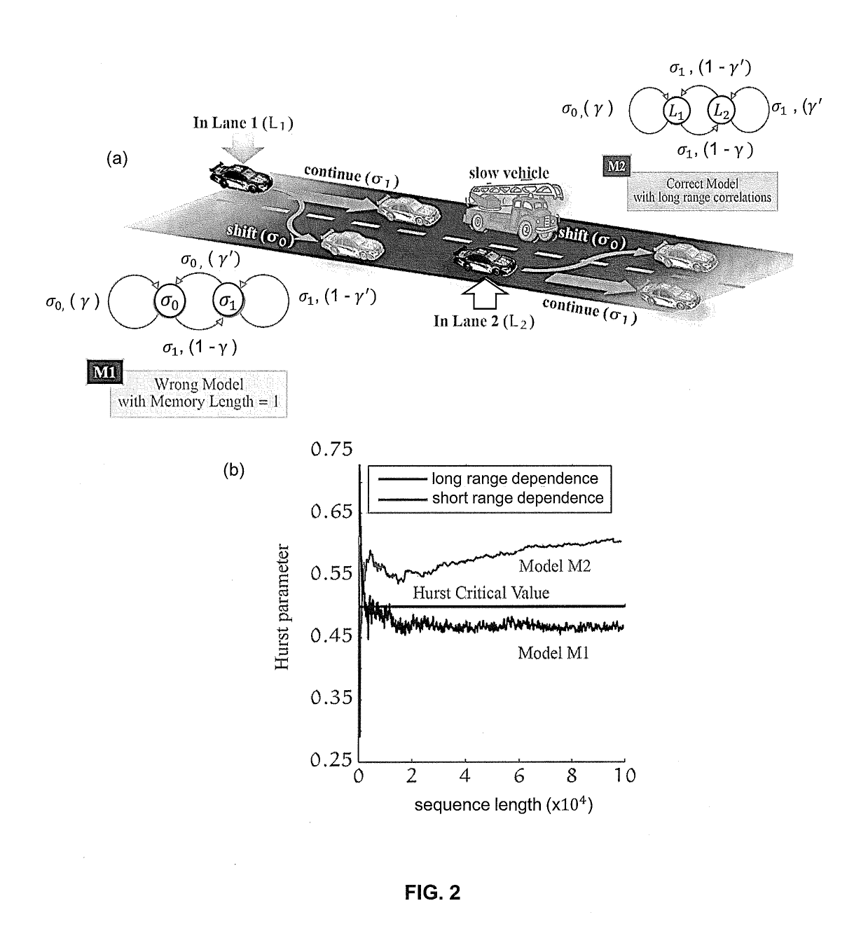

FIG. 2 is a conceptual diagram illustrating an example of a long-range dependencies. With reference to (a) in FIG. 2, consider the dynamics of lane switching for a car on the highway, which may shift lanes (symbol σ₀) or continue in the current lane (symbol σ₁), and these symbol probabilities depend on the lane that the car is in. The correct model for this rule is M2 (top), which is non-synchronizable, and no length of history will determine exactly the current state. The similar, but incorrect, model M1 (with transitions switched) is a PFSA with 1-step memory. The difference in dynamics is illustrated by the computation of the Hurst exponent for symbol streams generated by the two models (b), with σ₀ and σ₁ represented as 1 and −1. M2 has a Hurst exponent greater than 0.5, indicating LRD behaviour. The techniques described herein correctly identifies M2 from a sequence of driver decisions; while most reported algorithms identify models similar to M1.

The additional following issue has also been observed: (4) Inconsistent definition of probability space: Reported approaches often attempt to define a probability distribution on Σ*, i.e. the set of all finite but unbounded words over an alphabet Σ, and then additionally define the probability of the null-word λ to be 1. This is inconsistent, since the latter condition would demand that the probability of every other finite string in Σ* be 0. Some authors use λ for string termination, which is in line with the grammatical picture where the empty word is used to erase a non-terminal. However, this is inconsistent with a dynamical systems model. In some examples, the techniques described herein address this via rigorous construction of a σ-algebra on strictly infinite strings.

Further, some techniques use initial states (superfluous for stationary ergodic processes), special termination symbols and requires a pre-specified bound on the model size. The techniques described herein may be significantly more compact.

To summarize, the techniques described herein may (i) formalize PFSAs in the context of QSPs, (ii) remove inconsistencies with the definition of the probability of the null-word via a σ-algebra on strictly infinite strings, and (iii) show that PFSAs arise naturally via an equivalence relation on infinite strings. Also, the techniques described herein may characterize the class of QSPs with finite probabilistic generators, establish probably approximately correct (PAC)-learnability. Further, the techniques described herein may be used to learn PFSA models with no a priori restrictions on the structure, size and memory. Further, models generated from the techniques described herein have be tested against rigorous performance guarantees and data requirements, and have shown to correctly infer long-range dependencies.

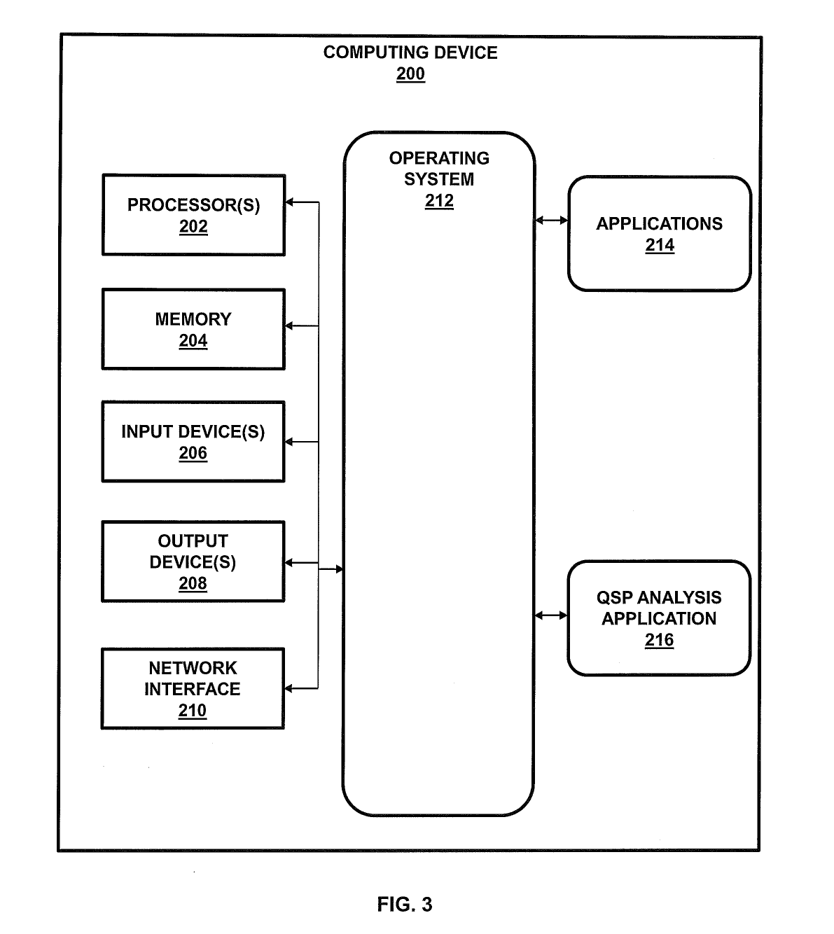

FIG. 3 is a block diagram illustrating an example of a computing device that may implement one or more techniques of this disclosure. Computing device 200 is an example of a computing device that may execute one or more applications, including QSP analysis application 216. Computing device 200 may include or be part of a portable computing device (e.g., a mobile phone, netbook, laptop, personal data assistant (PDA), or tablet device) or a stationary computer (e.g., a desktop computer, or set-top box). Computing device 200 includes processor(s) 202, memory 204, input device(s) 206, output device(s) 208, and network interface 210.

Each of processor(s) 202, memory 204, input device(s) 206, output device(s) 208, and network interface 210 may be interconnected (physically, communicatively, and/or operatively) for inter-component communications. Operating system 212, applications 214, and QSP analysis application 216 may be executable by computing device 200. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

Processor(s) 202 may be configured to implement functionality and/or process instructions for execution in computing device 200. Processor(s) 202 may be capable of retrieving and processing instructions, code, and/or data structures for implementing one or more of the techniques described herein. Instructions may be stored on a computer readable medium, such as memory 204. Processor(s) 202 may be digital signal processors (DSPs), general purpose microprocessors, application specific integrated circuits (ASICs), field programmable logic arrays (FPGAs), or other equivalent integrated or discrete logic circuitry.

Memory 204 may be configured to store information that may be used by computing device 200 during operation. As described above, memory 204 may be used to store program instructions for execution by processor(s) 202 and may be used by software or applications running on computing device 200 to temporarily store information during program execution. For example, memory 204 may store instructions associated with operating system 212, applications 214, and QSP application 216 or components thereof, and/or memory 204 may store information associated with the execution of operating system 212, applications 214, and QSP analysis application 216.

Memory 204 may be described as a non-transitory or tangible computer-readable storage medium. In some examples, memory 204 may provide temporary memory and/or long-term storage. In some examples, memory 204 or portions thereof may be described as volatile memory, i.e., in some cases memory 204 may not maintain stored contents when computing device 200 is powered down. Examples of volatile memories include random access memories (RAM), dynamic random access memories (DRAM), and static random access memories (SRAM). In some examples, memory 204 or portions thereof may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 206 may be configured to receive input from a user operating computing device 200. Input from a user may be generated as part of a user running one or more software applications, such as QSP analysis application 216. Input device(s) 206 may include a touch-sensitive screen, track pad, track point, mouse, a keyboard, a microphone, video camera, or any other type of device configured to receive input from a user.

Output device(s) 208 may be configured to provide output to a user operating computing device 200. Output may tactile, audio, or visual output generated as part of a user running one or more software applications, such as applications 214 and/or QSP analysis application 216. Output device(s) 210 may include a touch-sensitive screen, sound card, a video graphics adapter card, or any other type of device for converting a signal into an appropriate form understandable to humans or machines. Additional examples of an output device(s) 210 may include a speaker, a cathode ray tube (CRT) monitor, a liquid crystal display (LCD), or any other type of device that can provide output to a user.

Network interface 210 may be configured to enable computing device 200 to communicate with external devices via one or more networks. Network interface 210 may be a network interface card, such as an Ethernet card, an optical transceiver, a radio frequency transceiver, or any other type of device that can send and receive information. Network interface 210 may be configured to operate according to one or more communication protocols.

Operating system 212 may be configured facilitate the interaction of applications, such as applications 214 and QSP application 216, with processor(s) 202, memory 204, input device(s) 206, output device(s) 208, network interface 210 and other hardware components of computing device 200. Operating system 212 may be an operating system designed to be installed on laptops and desktops. For example, operating system 212 may be a Windows operating system, Linux, or Mac OS. In another example, if computing device 200 is a mobile device, such as a smartphone or a tablet, operating system 212 may be one of Android, iOS or a Windows mobile operating system.

Applications 214 may be any applications implemented within or executed by computing device 200 and may be implemented or contained within, operable by, executed by, and/or be operatively/communicatively coupled to components of computing device 200, e.g., processor(s) 202, memory 204, and network interface 210. Applications 214 may include instructions that may cause processor(s) 202 of computing device 200 to perform particular functions. Applications 214 may include algorithms which are expressed in computer programming statements, such as, for loops, while-loops, if-statements, do-loops, etc.

As described above real-world systems, such as, for example, probability of errors in signal transmission, flow of wealth in the stock market, geophysical phenomena, ecology of evolving ecosystems, genetic regulatory circuits and even social interaction dynamics may be modelled as quantized stochastic processes (QSPs). QSP analysis application 216 is an example of an application that may implement the techniques described herein in order to analyze QSP. In one example, QSP analysis application 216 may include unsupervised learning algorithms that when executed by processor(s) 202 may cause processor(s) 202 to infer a causal structure of quantized stochastic processes.

It is useful to formalize probabilistic generators for stochastic dynamical systems in order to provide a framework for algorithms that may be included in QSP analysis application 216 to infer a causal structure of quantized stochastic processes (i.e., describe the mathematical connection of QSPs to PFSA generators). This disclosure provides a series of definitions, lemmas, and theorems (i.e., 2.1 through 2.18) below in order to provide a framework for algorithms that may be included in QSP analysis application 216. It should be noted that for the sake of clarity additional some of the proofs with respect to the definitions, lemmas, and theorems are provided in Appendix A instead of the text below.

Throughout this disclosure, Σ denotes a finite alphabet of symbols and the set of all finite but possibly unbounded strings on Σ is denoted by Σ*, the Kleene* operation. The set of finite strings over Σ form a concatenative monoid, with the empty word λ as identity. In this disclosure, concatenation of two strings x, yεΣ* is written as xy. Thus, xy=xλy=xyλ=λxy. In this disclosure, the set of strictly infinite strings on Σ is denoted as Σ^{ω}, where ω denotes the first transfinite cardinal. For a string xεΣ*, |x| denotes the length of x and for a set A, |A| denotes its cardinality.

Definition 2.1 (QSP).

A QSP H is a discrete time Σ-valued strictly stationary, ergodic stochastic process, i.e.

H={Xₜ:Xₜ is a Σ-valued random variable for tεN∪{0}}.

A stochastic process is ergodic if moments can be calculated from a single, sufficiently long realization, and strictly stationary if moments are not functions of time.
Next the connection of QSPs to PFSA generators is formalized.

Definition 2.2 (σ-Algebra on Infinite Strings).

For the set of infinite strings on Σ, B is defined to be the smallest σ-algebra generated by {xΣ^{ω}:xεΣ*}.

Lemma 2.3.

Any QSP induces a probability space (Σ^{ω}, μ).

Proof. Using stationarity of QSP H, a probability measure μ: B→[0, 1] can be constructed by defining for any sequence xεΣ*\{λ}, and a sufficiently large number of realizations N_{R} of H, with fixed initial conditions:

$$μ ( x {Σ}^{ω} ) = {lim}_{{N}_{R} \to ∞} \frac{( number of initial occurrences of x )}{( \begin{matrix}number of initial occurrences \\ of all sequences of length \vert x \vert\end{matrix} )}$$

and extending the measure to elements of B\B via at most countable sums. It should be noted that μ(Σ^{ω})=Σ_{xεΣ*}μ(xΣ^{ω})=1, and for the null word μ(xΣ^{ω})=μ(Σ^{ω})=1. For notational brevity, μ(xΣ^{ω}) is denoted as Pr(x). Classically, states are induced via the Nerode equivalence, which defines two strings to be equivalent if and only if any finite extension of the strings is either both accepted or both rejected by the language under consideration. For the example techniques described herein a probabilistic extension is used.

Definition 2.4 (Probabilistic Nerode Relation).

(Σ^{ω}, B, μ) induces an equivalence relation ˜N on the set of finite strings Σ* as

$$∀ x , y ∈ {Σ}^{*} , x ∼ Ny ⇔ ∀ z ∈ {Σ}^{*} ( ( Pr ( xz ) = Pr ( yz ) = 0 ) ⋁ \vert \frac{Pr ( xz )}{Pr ( x )} - \frac{Pr ( yz )}{Pr ( y )} \vert = 0 ) . \qquad ( 2.1 )$$

For xεΣ*, the equivalence class of x is denoted as [x]. It follows that ˜N is right invariant, i.e.

x˜Ny [symbol] ∀zεΣ*,xz˜Nyz (2.2)

A right-invariant equivalence on Σ* always induces an automaton structure.

Definition 2.5 (Initial-Marked PFSA).

An initial-marked PFSA is a 5-tuple (Q, Σ, δ, π^{˜}, q₀), where Q is a finite state set, Σ is the alphabet, δ: Q×E→Q is the state transition function, and π^{˜}: Q×Σ→[0, 1] specifies the conditional symbol-generation probabilities. δ and π^{˜} are recursively extended to arbitrary y=σ×εΣ* as δ(q, σx)=δ(δ(q,σ),x) and π^{˜}(q, σx)=π^{˜}(q,σ)π^{˜}(δ(q, σ), x). q0εQ is the initial state. If the next symbol is specified, our resultant state is fixed; similar to probabilistic deterministic automata. However, unlike the latter, techniques described herein may lack final states. Additionally, techniques described herein may assume graphs to be strongly connected. Definition 2.5 has no notion of a final state, and later initial state dependence will be removed using ergodicity. First, the notion of a PFSA arises from a QSP is formalized.

Lemma 2.6 (from QSP to a PFSA).

If the probabilistic Nerode relation has a finite index, then there exists an initial-marked PFSA generator.

Proof Every QSP represented as a probability space (Σ^{ω}, B, μ) induces a probabilistic automaton (Q, Σ, δ, π^{˜}, q₀), where Q is the set of equivalence classes of the probabilistic Nerode relation (definition 2.4), Σ is the alphabet, and

$$\begin{matrix}δ ( [ x ] , σ ) = [ x σ ] \\ and & ( 2.3 ) \\ \tilde{π} ( [ x ] , σ ) = \frac{Pr ( {x}^{′} σ )}{Pr ( {x}^{′} )} \\ for any choice of {x}^{′} ∈ [ x ] . & ( 2.4 )\end{matrix}$$

q₀ is identified with [λ], and finite index of ˜_{N} implies |Q|<∞
The above construction yields a minimal realization unique up to state renaming.

Corollary 2.7 (to Lemma 2.6: Null-Word Probability).

For the PFSA (Q, Σ, δ, π^{˜}) induced from a QSP H:

∀qεQ,\tilde{π}(q,λ)=1. (2.5)

Proof. For qεQ, let xεZ* such that [x]=q. From equation (2.4),

$$\begin{matrix}\tilde{π} ( q , λ ) = \frac{Pr ( {x}^{′} λ )}{Pr ( {x}^{′} )} for {x}^{′} ∈ [ x ] \\ = \frac{Pr ( {x}^{′} )}{Pr ( {x}^{′} )} \\ = 1.\end{matrix} \qquad ( 2.6 )$$

Next, canonical representations are defined to remove initial-state dependence. π^{˜} is used to denote the matrix representation of π^{˜}, i.e. π^{˜}ᵢⱼ=π(qᵢ, σⱼ), qᵢεQ, σⱼεΣ. Further, the notion of transformation matrices Γ_{σ} is needed.

Definition 2.8 (Transformation Matrices).

For an initial-marked PFSA G=(Q,Σ, δ, π^{˜}, q₀), the symbol-specific transformation matrices Γ_{σ}ε{0, 1}^{|Q|×|Q|} are

$${Γ}_{σ \vert ij} = \{ \begin{matrix}\tilde{π} ( {q}_{i} , σ ) & if δ ( {q}_{i} , σ ) = {q}_{j} , \\ 0 & otherwise .\end{matrix} \qquad ( 2.7 )$$

States in the canonical representation (denoted as [symbol] x) are identified with probability distributions over states of the initial-marked PFSA. Here, x denotes the string in Σ* realizing this distribution, beginning from the stationary distribution on the states of the initial-marked representation. [symbol] x is an equivalence class, and hence x is not unique.

Definition 2.9 (Canonical Representations).

An initial-marked PFSA G=(Q, Σ, δ, π^{˜}, q₀) uniquely induces a canonical representation (Q^{C}, Σ, δ^{C}, π^{˜C}), with Q^{C} being the set of probability distributions over Q, δ^{C}:Q^{C}×Σ→Q^{C}, and π^{˜C}:Q^{C}×Σ→[0, 1], as follows.
Construct the stationary distribution on Q using the transition probabilities of the Markov chain induced by G, and include this as the first element [symbol] _{λ} of Q^{C}. The transition matrix for this induced chain is the row-stochastic matrix Mε[0, 1]^{|Q|×|Q|}, with Mᵢⱼ=Σ_{o:δ(qi,σ)}=_{qj}π^{˜}(qᵢ, σ).
Define δ^{C} and π^{˜C} recursively:

$$\begin{matrix}{δ}^{C} ( {x}_{} , σ ) = \frac{1}{{‖ {x}_{} {Γ}_{σ} ‖}_{1}} {x}_{} {Γ}_{σ} {=}^{Δ} {x σ}_{} \\ and & ( 2.8 ) \\ {\tilde{π}}^{C} ( {x}_{} , σ ) = {x}_{} \tilde{Π} . & ( 2.9 )\end{matrix}$$

For a QSP H, the canonical representation is denoted as C_{H}.

Ergodicity of QSPs, which makes [symbol] λ independent of the initial state in the initial-marked PFSA, implies that the canonical representation is initial state independent, and subsumes the initial-marked representation in the following sense: let E={eiε[0 1]|Q|, i=1, . . . , |Q|} denote the set of distributions satisfying

$${e}^{i} {\vert}_{j} = \{ \begin{matrix}1 & if i = j , \\ 0 & otherwise .\end{matrix} \qquad ( 2.10 )$$

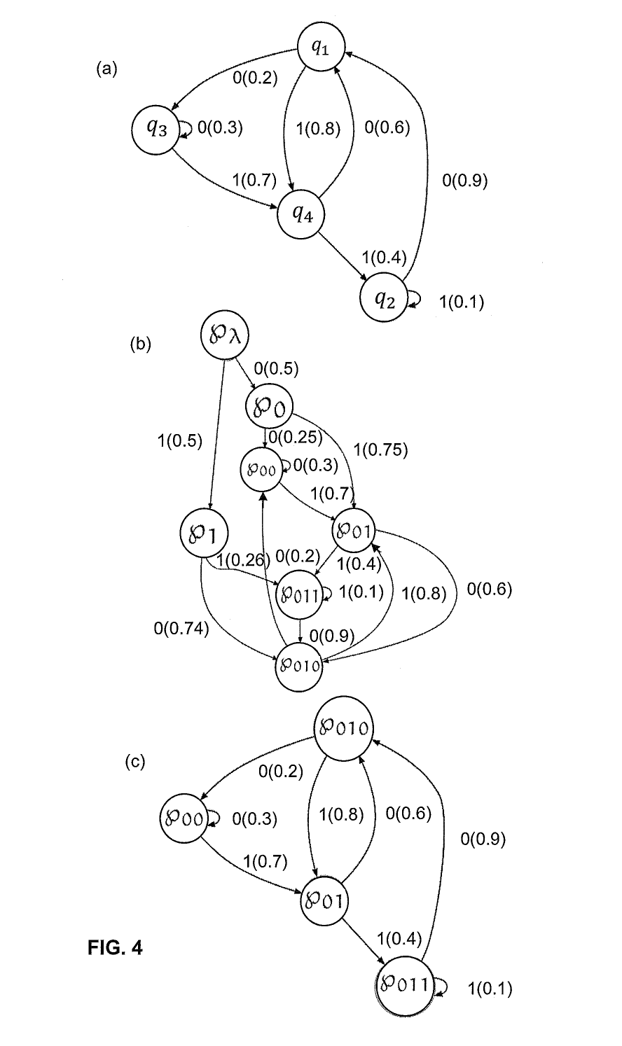

FIG. 4 is a conceptual diagram illustrating an example of canonical representations. In the example illustrated in FIG. 4, an initial-marked PFSA (a), and the canonical representation obtained starting with the stationary distribution [symbol] λ on the states q1, q2, q3 and q4 (b). In this case, a finite graph is obtained here, which is not guaranteed in general. The strongly connected component, which is isomorphic to the original PFSA. States of the machine in (c) are distributions over the states of the machine in (a).

The following is noted:
If the canonical construction is executed with an initial distribution from E, then the initial-marked PFSA is obtained (with the initial marking missing).
If during the construction [symbol] xεE is encountered for some x, then an algorithm may stay within the graph of the initial-marked PFSA for all right extensions of x. This thus eliminates the need of knowing the initial state explicitly, provided string x is found, which takes an algorithm within or close to E.

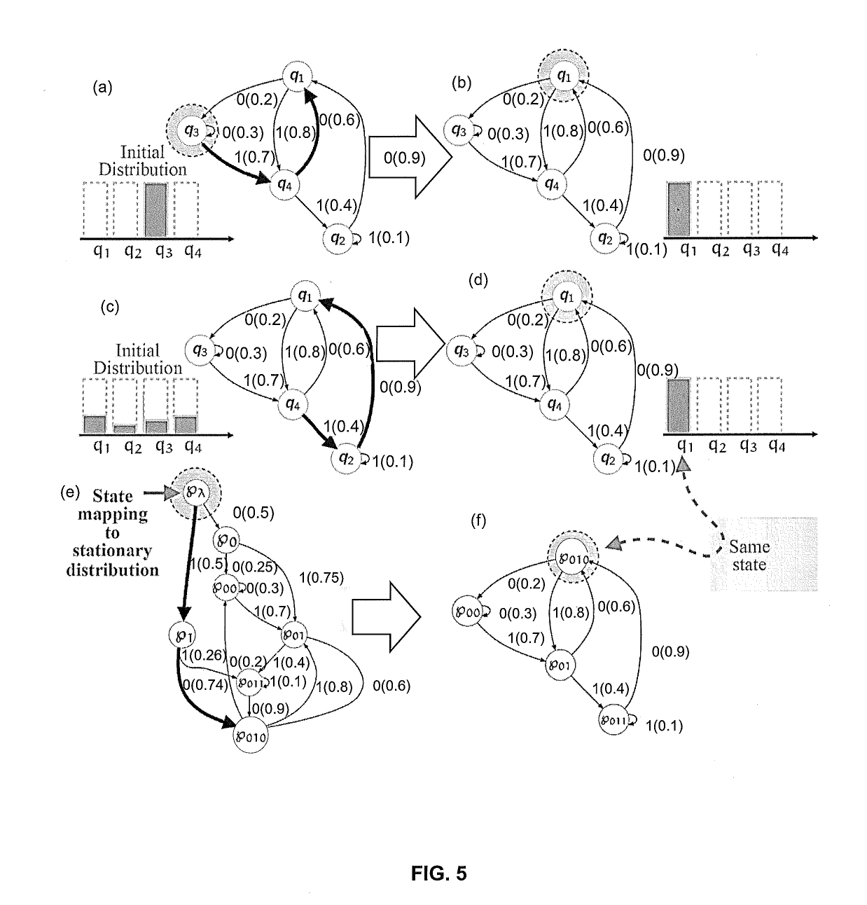

FIG. 5 is a conceptual diagram illustrating the concept of knowledge of initial states. In the example illustrated in FIG. 5, a sequence 10 is executed in the initial-marked PFSA in 5(a) from q₃ (transitions shown in bold), resulting in the new state q₁ (b). For this model, the same final state would be obtained by executing 10 from any other initial state, and also from any initial distribution over the states (as shown in (c) and (d)). This is because 10 is a synchronizing string for this model. Thus, if the initial state is unknown, and it can be assumed that the initial distribution is stationary, then an algorithm may actually start from the state [symbol] λ in the canonical representation (e), and would end up with a distribution that has support on a unique state in the initial-marked machine (see (f), where the resulting state in the pruned representation corresponds to q₁ in the initial-marked machine). Knowing a synchronizing string (of sufficient length) therefore makes the initial condition irrelevant. In the example illustrated in FIG. 5, this machine is perfectly synchronizable, which is not always true (e.g., model M2 in FIG. 2). However, approximate synchronization is always achievable (theorem 2.10), which therefore eliminates the need of knowing the initial state explicitly, but requires an algorithm to compute such an ε-synchronizing sequence.

Consequently, the initial-marked PFSA induced by a QSP H, with the initial marking removed may be denoted as P_{H}, and referred to simply as a ‘PFSA’ (dropping the qualifier ‘initial-marked’). States in P_{H} are representable as states in C_{H} as elements of E. Next, a key result is established: a state arbitrarily close to some element in E in the canonical construction starting from the stationary distribution [symbol] λ is always encountered.

Theorem 2.10 (ε-Synchronization of Probabilistic Automata).

For any QSP H over Σ, the PFSA P_{H} satisfies

ε′>0,∃xεΣ*,∃θεε,∥ [symbol] x−θν≦ε′, (2.11)

where the norm used is unimportant.

Proof. See Appendix A.

Theorem 2.10 induces the notion of ε-synchronizing strings, and guarantees their existence for arbitrary PFSA.

Definition 2.11 (ε-synchronizing strings). An ε-synchronizing string xεΣ* for a PFSA is one that satisfies

∃θεε,∥ [symbol] x−θ∥≦ε (2.12)

The norm used is unimportant.

It should be noted that Theorem 2.10 does not yield an algorithm for computing synchronizing strings (theorem 2.18). It simply shows that one always exists. As a corollary, the techniques herein may estimate an asymptotic upper bound on the effort required to find it.

Corollary 2.12 (to Theorem 2.10).

At most O(1/_{ε}) strings need to be analysed to find an ε-synchronizing string.

Proof. See appendix A.

Next, the basic principle of an inference algorithm is described. PFSA states are not observable; symbols generated from hidden states may be observed. This leads to the notion of symbolic derivatives, which are computable from observations.

The set of probability distributions over a set of cardinality k are denoted as D(k). First, a count function is specified.

Definition 2.13 (Symbolic Count Function).

For a string s over Σ, the count function #^{s}: Σ*→N∪{0} counts the number of times a particular substring occurs in s. The count is overlapping, i.e., in a string s=0001, the number of occurrences of 00s are counted as 0001 and 0001, implying #^{s}00=2.

Definition 2.14 (Symbolic Derivative).

For a string s generated by a QSP over Σ, the symbolic derivative is a function φ^{s}: Σ*→D(|Σ|−1) as

$${φ}^{s} ( x ) {\vert}_{i} = \frac{{\#}^{s} x {σ}_{i}}{{\sum }_{{σ}_{i} ∈ Σ} {\#}^{s} x {σ}_{i}} . \qquad ( 2.13 )$$

Thus, ∀xεΣ*, φ^{s}(x) is a probability distribution over Σ. φ^{s}(x) is referred to as the symbolic derivative at x. For qᵢεQ, π^{˜} induces a distribution over Σ as [π^{˜}(qᵢ, σ₁), . . . , π^{˜}(qᵢ, σ_{|Σ|})]. This is denoted as π^{˜}(qᵢ,•). It can be shown that the symbolic derivative at x can be used to estimate this distribution for qi=[x], provided x is ε-synchronizing.

Theorem 2.15 (ε-Convergence).

If xεΣ* is ε-synchronizing then

$$∀ ε > 0 , \\ {lim}_{\vert s \vert \to ∞} {‖ {φ}^{s} ( x ) - \tilde{π} ( [ x ] , \cdot ) ‖}_{∞} {≦}_{a . s .} ε . \qquad ( 2.14 )$$

Proof. The proof follows from the Glivenko-Cantelli theorem on uniform convergence of empirical distributions. See Appendix A for details.

Next, identification of ε-synchronizing strings given a sufficiently long observed string s is described. Theorem 2.10 guarantees existence, and corollary 2.12 establishes that O(1/_{ε}) substrings need to be analyzed until an ε-synchronizing string is encountered. It should be noted that Theorem 2.10 and corollary 2.12 do not provide an executable algorithm, which arises from an inspection of the geometric structure of the set of probability vectors over Σ, obtained by constructing φ^{s}(x) for different choices of the candidate string x.

Definition 2.16 (Derivative Heap).

Given a string s generated by a QSP, a derivative heap D^{s}: 2^{Σ*}→D(|Σ|−1) is the set of probability distributions over Σ calculated for a given subset of strings L⊂Σ* as follows:

D^{S}(L)={φ^{S}(x):xεL⊂Σ*}. (2.15)

Lemma 2.17 (Limiting Geometry).

Let D_{∞}=lim_{|s|→∞}lim_{L→Σ*}Ds(L), and U_{∞} be the convex hull of D_{∞}. If u is a vertex of U_{∞}, then

∃qεQ such that u=\tilde{π}(q,•). (2.16)

Proof. Recalling theorem 2.15, the result follows from noting that any element of D_{∞} is a convex combination of elements from the set {π^{˜}(q1, •), . . . , π^{˜}(q_{|Q|}, •)}

It should be noted that Lemma 2.17 does not claim that the number of vertices of the convex hull of D_{∞} equals the number of states, but that every vertex corresponds to a state. It should be noted that D_{∞} cannot be generated in practice since there is a finite observed string s, and only φ^{s}(x) for a finite number of x can be calculated. Instead, it can be shown that choosing a string corresponding to the vertex of the convex hull of the heap, constructed by considering O(1/_{ε}) strings, gives an ε-synchronizing string with high probability.

Theorem 2.18 (Derivative Heap Approximation).

For s generated by a QSP, let D^{s}(L) be computed with L=Σ^{O(log(1/}^{_{ε}}⁾⁾. If for some x₀εΣ^{O(log(1/E))}, φs(x₀) is a vertex of the convex hull of Ds(L), then

Prob(x₀ is not ε-synchronizing)≦e^{-|s|εO(1)}. (2.17)

Proof. The result follows from Sanov's theorem for convex set of probability distributions. See Appendix A for details.

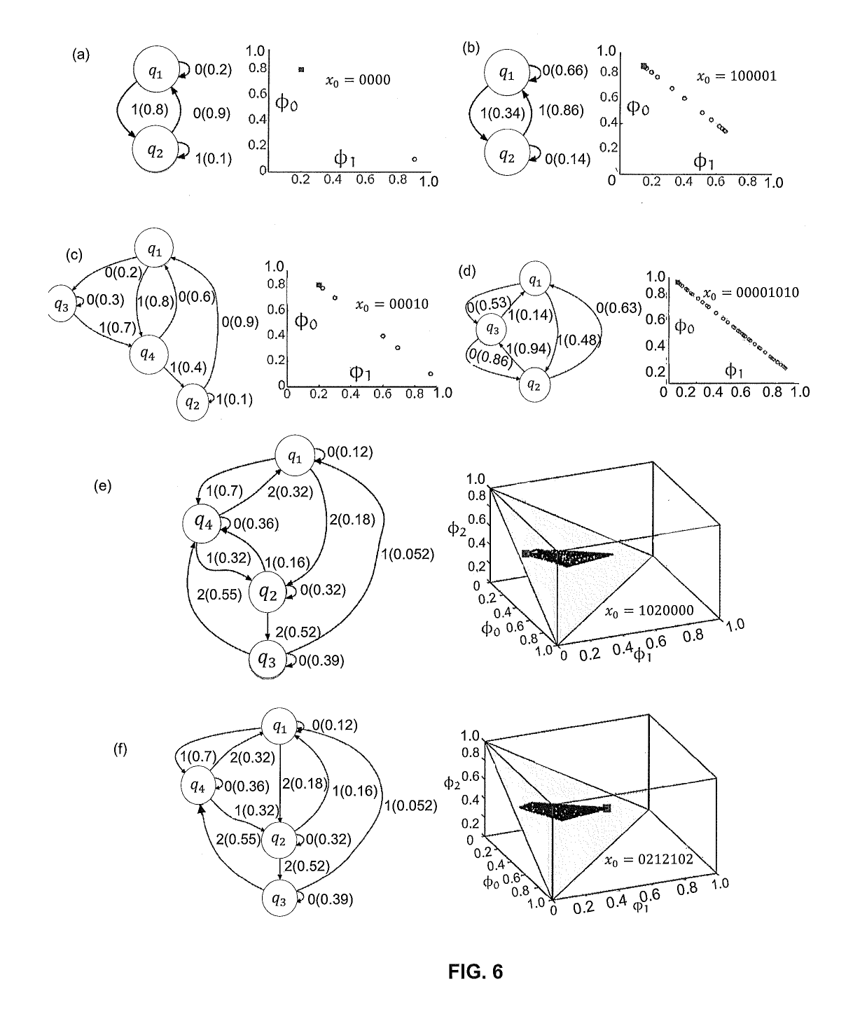

FIG. 6 is a conceptual diagram illustrating PFSAs, derivative heaps, and ε-synchronizing strings. In the example, illustrated in FIG. 6, Synchronizable PFSAs (a,c), and hence the derivative heaps have few distinct images (two for (a), and about five for (c)), while the PFSAs shown in (b) and (d) are non-synchronizable, and their heaps consist of a spread of points. It should be noted that since the alphabet size is two in these cases, the heaps are part of a line segment. PFSAs and derivative heaps for 3-letter alphabets are illustrated in (e) and (f). The derivative heap is a polytope as expected. The square marks the derivative at the chosen ε-synchronizing string x₀ in all cases. φᵢ is the ith coordinate of the symbolic derivative.

Based on the framework described above with respect to definitions, lemmas, and theorems 2.1 through 2.18. QSP analysis application 216 and computing device 200 may implement one or more algorithms for inferring a PFSA. In one example, an algorithm may be referred to as ‘Generator Extraction Using Self-similar Semantics’, or GenESeSS. In one example, for an observed sequence s, an algorithm may include the following: identification of ε-synchronizing string x₀, identification of the structure of P_{H}, i.e. transition function δ, and identification of arc probabilities, i.e. function π^{˜}.

In one example, computing device 200 may identify a ε-synchronizing string x₀ by constructing a derivative heap D^{s}(L) using the observed trace s (definition 2.16), and set L consisting of all strings up to a sufficiently large, but finite, depth. In one example, an initial choice of L may include as log_{|Σ|}1/_{ε}. If L is sufficiently large, then the inferred model structure will not change for larger values. Computing device 200 may then identify a vertex of the convex hull for D_{∞}, via an algorithm for computing the hull. For example, Barber C B, Dobkin D P, Huhdanpaa H. 1996 the quickhull algorithm for convex hulls. ACM Trans. Math. Softw. 22, 469-483, which is incorporated by reference herein, provides an algorithm for computing the hull. Computing device 200 may choose x₀ as the string mapping to this vertex.

In one example, computing device 200 may generate δ as follows. For each state q, computing device 200 may associate a string identifier x_{q}^{id}εx0Σ*, and a probability distribution h_{q} on Σ (which is an approximation of π^{˜}-row corresponding to state q). Computing device 200 may extend the structure recursively as follows:
(i) Initialize the set Q as Q={q0}, and set x_{q0}^{id}=x₀, h_{q}=φ^{s}(x₀).
(ii) For each state qεQ, compute for each symbol σεΣ, find symbolic derivative φ^{s}(x_{q}^{id}σ). If ∥φ^{s}(x_{q}^{id}σ)−h_{qσ}∥_{∞}≦ε for some qεQ, then define δ(q, σ)=q. If, on the other hand, no such q can be found in Q, then add a new state q to Q, and define x_{q}^{id}=x_{q}^{id}σ, h_{qσ}=φ^{s}(x_{q}^{id}σ).
   The process terminates when every qεQ has a target state, for each σεΣ. Then, if necessary, computing device 200 may ensure strong connectivity using techniques described in Tarjan R. 1972 Depth-first search and linear graph algorithms. SIAM J. Comput. 1, 146-160, which is incorporated by reference herein.

In one example, computing device 200 may identify arc probabilities as follows:
(i) choose an arbitrary initial state qεQ.
(ii) Run sequence s through the identified graph, as directed by δ, i.e. if current state is q, and the next symbol read from s is σ, then move to δ(q,σ). Count arc traversals, i.e. generate numbers Nⱼⁱ where

$${q}_{i} {{\to }^{{σ}_{j}}}_{{N}_{j}^{i}} {q}_{k} .$$

(iii) Generate π^{˜} by row normalization, i.e. π^{˜}ᵢⱼ=Nⱼⁱ/(ΣⱼNⱼⁱ).

It should be noted that although other competing techniques may use a similar recursive structure extension. These techniques have no notion of ε-synchronization i.e., they are restricted to inferring only synchronizable or short-memory models, or large approximations for long-memory ones. In this manner, computing device 200 represents an example of a computing device configured to infer a probabilistic finite state automation.

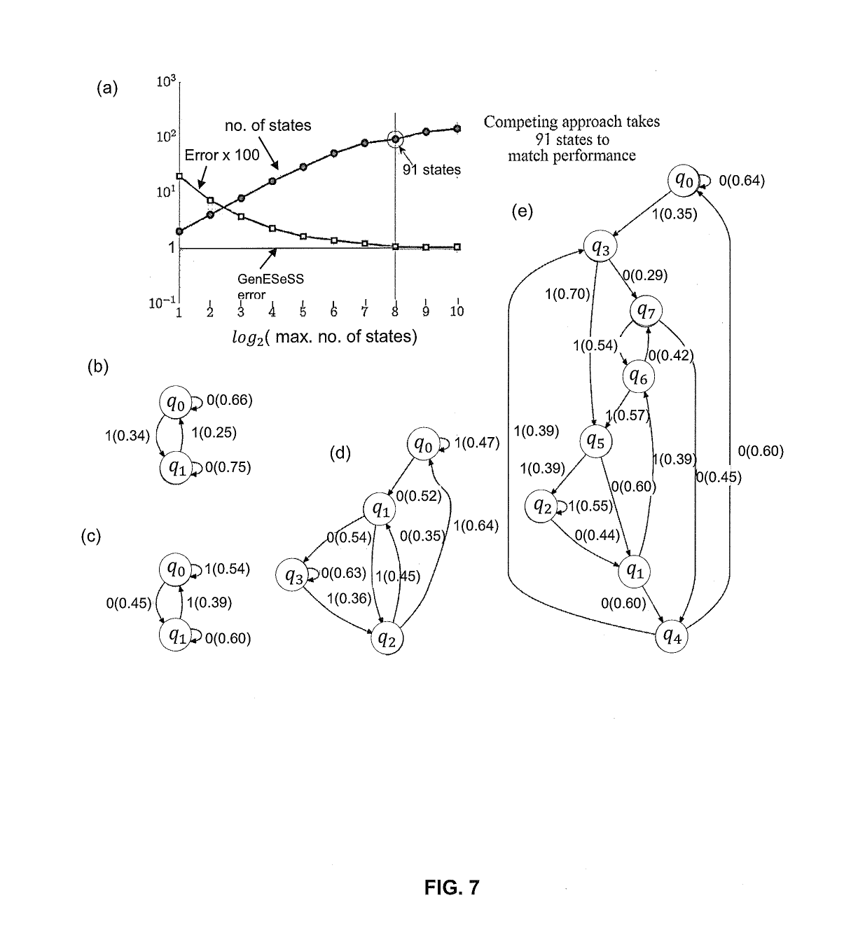

FIG. 7 is a conceptual diagram comparing the techniques described herein to other techniques. FIG. 7 illustrates the application of a competing algorithm on simulated data from model M2 (illustrated in FIG. 3) with ε=0.05. As illustrated in FIG. 7, (a) the modelling error in the metric defined in lemma 3.2 with increasing model size, requiring 91 states to match GenESeSS performance (which finds the correct 2 state model M2 (b)). The competing algorithm requires a maximum model size, and (c)-(e) in FIG. 7 show models obtained with 2, 4 and 8 states. In the example illustrated in FIG. 7, all models found are synchronizable, and miss the key point found by GenESeSS that M2 is non-synchronizable with LRDs. Other algorithms also finds only similar synchronizable models.

Theorem 3.1 below provides a complexity analysis of the techniques described herein. While h_{q} described above with respect to identification of the transition function δ approximates π^{˜} rows, arc probabilities may be found via normalization of traversal count. h_{q} only uses sequences in x₀Σ*, while traversal counting uses the entire sequence s, and is more accurate. GenESeSS has no upper bound on the number of states; which is a function of the complexity of the process itself.

Theorem 3.1 (Time Complexity).

Asymptotic time complexity of GenESeSS is

$$𝒯 = O ( ( \frac{1}{ε} + \vert Q \vert ) \times \vert s \vert \times \vert Σ \vert ) . \qquad ( 3.1 )$$

Proof. See appendix A for details.

Theorem 3.1 shows that GenESeSS is polynomial in O(1/_{ε}), size of input s, model size |Q| and alphabet size |Σ|. In practice, |Q|<<1/_{ε}, implying that

$$𝒯 = O ( \frac{\vert s \vert \vert Σ \vert}{ε} ) . \qquad ( 3.2 )$$

An identification method is said to identify a target language L* in the PAC sense if it always halts and outputs L such that

∃ε,δ>0,P(d(Lₖ,L)≦ε)≧1−δ, (3.3)

where d(•, •) is a metric on the space of target languages. A class of languages is efficiently PAC-learnable if there exists an algorithm that PAC-identifies every language in the class, and runs in time polynomial in 1/_{ε}, 1/δ, the length of sample input, and inferred model size. The PAC-learnability of QSPs can be proven by first establishing a metric on the space of probabilistic automata over Σ.

Lemma 3.2 (Metric for Probabilistic Automata).

For two strongly connected PFSAs G1 and G2, denote the symbolic derivative at xεΣ* as φ^{s}_{G1}(x) and φ^{s}_{G2}(x), respectively. Then,

$$Θ ( {G}_{1} , {G}_{2} ) = {sup}_{x ∈ {Σ}^{*}} \{ J ( x ) = {lim}_{\vert {s}_{1} \vert \to ∞} {lim}_{\vert {s}_{2} \vert \to ∞} {‖ {φ}_{{G}_{1}}^{{s}_{1}} ( x ) - {φ}_{{G}_{2}}^{{s}_{2}} ( x ) ‖}_{∞} \}$$

define s a metric on the space of probabilistic automata on Σ.

Proof. Non-negativity and symmetry follow immediately. Triangular inequality follows from noting that ∥φ^{s1}_{G1}(x) and φ^{s2}_{G2}(x)∥_{∞} is upper bounded by 1, and therefore for any chosen order of the strings in Σ*, have two I_{∞} sequences, which would satisfy the triangular inequality under the sup norm. The metric is well defined since for any sufficiently long s₁ and s₂, the symbolic derivatives at arbitrary x are uniformly convergent to some linear combination of the rows of the corresponding π^{˜} matrices.

Theorem 3.3 (PAC-Learnability).

QSPs for which the probabilistic Nerode equivalence has a finite index are PAC-learnable using PFSAs, i.e. for ε, η>0, and for every sufficiently long sequence s generated by QSP H, P′_{H} can be computed as an estimate for P_{H} such that

Prob(Θ(P_{H},P′_{H})≦ε)≧1−η. (3.4)

The algorithm runs in time polynomial in 1/ε, 1/η, input length |s| and model size.

Proof. GenESeSS construction implies that, once the initial ε-synchronizing string x₀ is identified, there is no scope of the model error to be more than ε. Hence

Prob(Θ(P_{H},P′_{H})≦ε)=1−Prob(∥φ^{s}(x₀)− [symbol] ₓ₀\tilde{π}∥_{∞}>ε) [symbol] Prob(Θ(P_{H},P′_{H})≦ε)≧1−e^{-|s|εO(1)} (using equation (A 12)).

Thus, for any η>0, if this is |s|=O(1/E log 1/η), then the required condition of equation (3.4) is met. The polynomial runtimes are established in theorem 3.1.

In should be noted that some of the example techniques described herein are immune to Kearns' hardness result, since E>0 enforces state distinguishability.

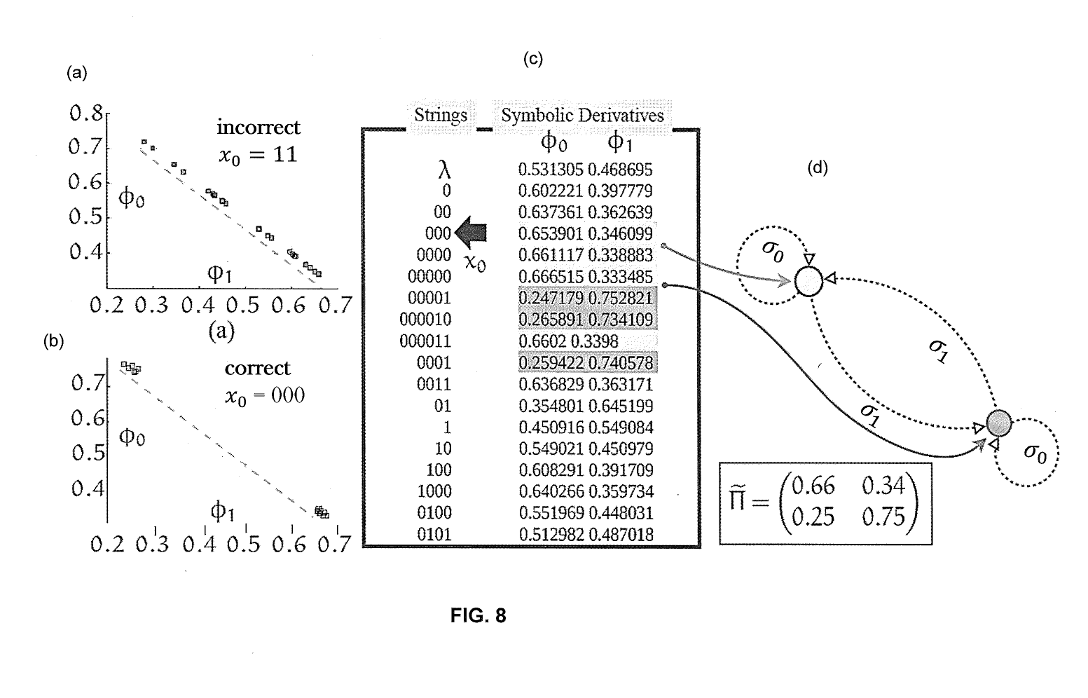

The application of GenESeSS to simulated data is described below. FIG. 8 is a conceptual diagram illustrating example techniques described herein to a simulated data. In the example illustrated in FIG. 8, for the scenario in FIG. 2, GenESeSS is applied to 103 symbols generated from the model M2 (denoting σ0 as 0, and σ1 as 1) with parameters γ=0.75 and γ1=0.66. A derivative heap with all strings of length up to 4 is generated, and 000 mapping to an estimated vertex of the convex hull of the heap is found, thus qualifying as the ε-synchronizing string x₀.

FIGS. 8 (a) and (b) illustrate the choice of a ‘wrong’ x₀; the theoretical development guarantees that if x₀ is close to a vertex of the convex hull, then the derivatives φ^{s}(x₀x) will be close to some row of π^{˜}, and thus form clusters around those values. If the chosen x₀ is far from all vertices, this is not true; thus, in (a) of FIG. 8, the incorrect choice of string 11 leads to a spread of symbolic derivatives on the line x+y=1. In FIG. 8 (b) illustrates clustering of the values around the two hidden states with x₀=000. A few symbolic derivatives are shown in figure (c), with highlighted rows corresponding to strings with x₀ as prefix; which are approximate repetitions of two distinct distributions.

Switching between these repeating distributions on right concatenation of symbols induces the structure shown in (d) for ε=0.05. The inferred model is already strongly connected, and input data is run through it to estimate the IT matrix (see the inset of (d). The model is recovered with correct structure, and with deviation in π^{˜} entries smaller than 0.01. This example infers a non-synchronizable machine (recall that M2 exhibits LRDs), which often proves to be too difficult for reported unsupervised algorithms (see comparison with the other techniques in FIG. 7, which can match GenESeSS performance only at the expense of a large number of states, and yet still fails to infer true LRD models). Hidden Markov model learning with latent transitions can possibly be applied; however, such algorithms do not come with any obvious guarantees on performance.

The application of GenESeSS to model and predict experimental data is described below. In the example below GenESeSS is applied to two experimental datasets: photometric intensity (brightness) of a variable star for a succession of 600 days, and twice-daily count of bow-fly population in a jar. While the photometric data are quasi-periodic, the population time series has non-trivial stochastic structure. Quantization schemes, with four symbols, are shown in Table 1.

TABLE 1

| | | Range of | | | Com- |
|---|---|---|---|---|---|
| | | change | mean | | parative |
| | | between | change | Infer- | ARMAX |
| | | obser- | repre- | red | model |
| System | Symbol | vations | sented | PFSA | order |
| Bow-fly | 0 | [−1500, −200] | −540.68 | No. of | (15, 5) |
| population | | | | states: 9 | |
| in a jar | | | | | |
| | 1 | [−200, 0] | −87.66 | | |
| | 2 | [0, 200] | 70.4 | | |
| | 3 | [200, 1500] | 507.12 | | |
| Photometry | 0 | [−4, −2] | −2.67 | No. of | (3, 1) |
| from | | | | states: 8 | |
| variable | | | | | |
| star | | | | | |
| | 1 | [−2, 0] | −0.44 | | |
| | 2 | [0, 2] | 1.35 | | |
| | 3 | [2, 4] | 3.12 | | |

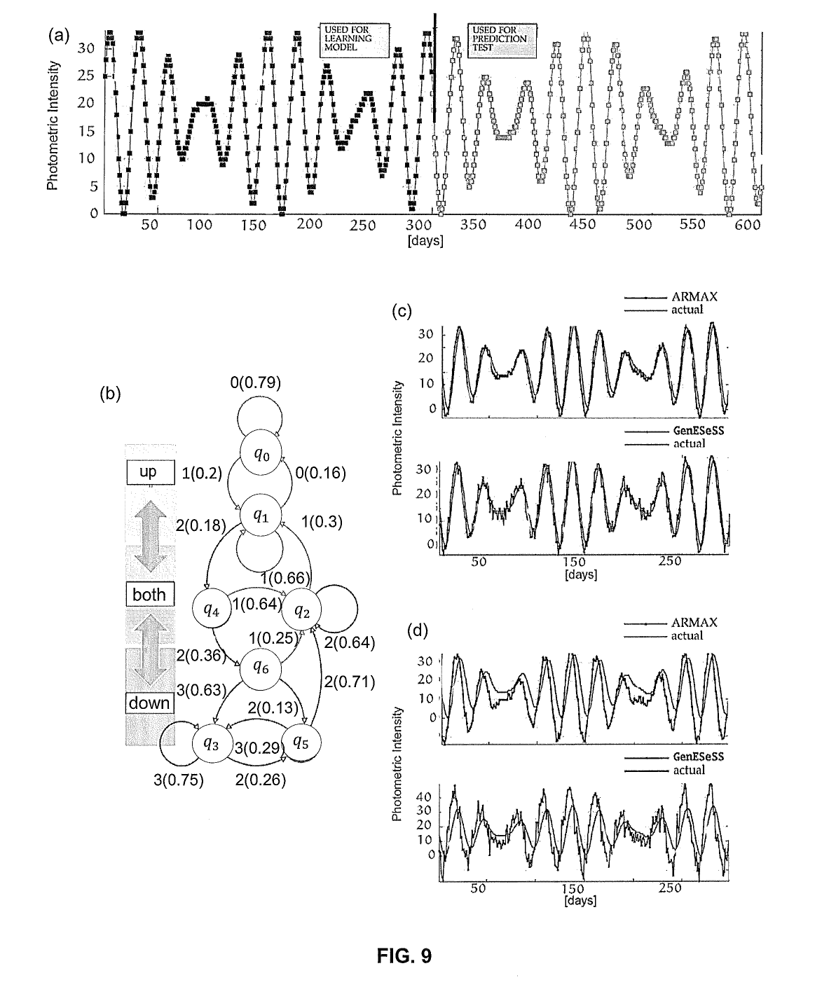

FIGS. 9-11 illustrate the application of GenESeSS to model and predict experimental data compared to other techniques. The mean magnitude of successive change represented by each symbol is also shown, which is computed as the average of the continuous values that get mapped to each symbol, e.g. for the photometric data, symbol 0 represents a change of brightness in the range [−4, −2], and an average change of −2.67. Inferred PFSAs generate symbolic sequences, which are mapped back to the continuous domain using these average magnitudes, e.g. a generated 0 is interpreted as a change of −2.67 for photometric predictions.

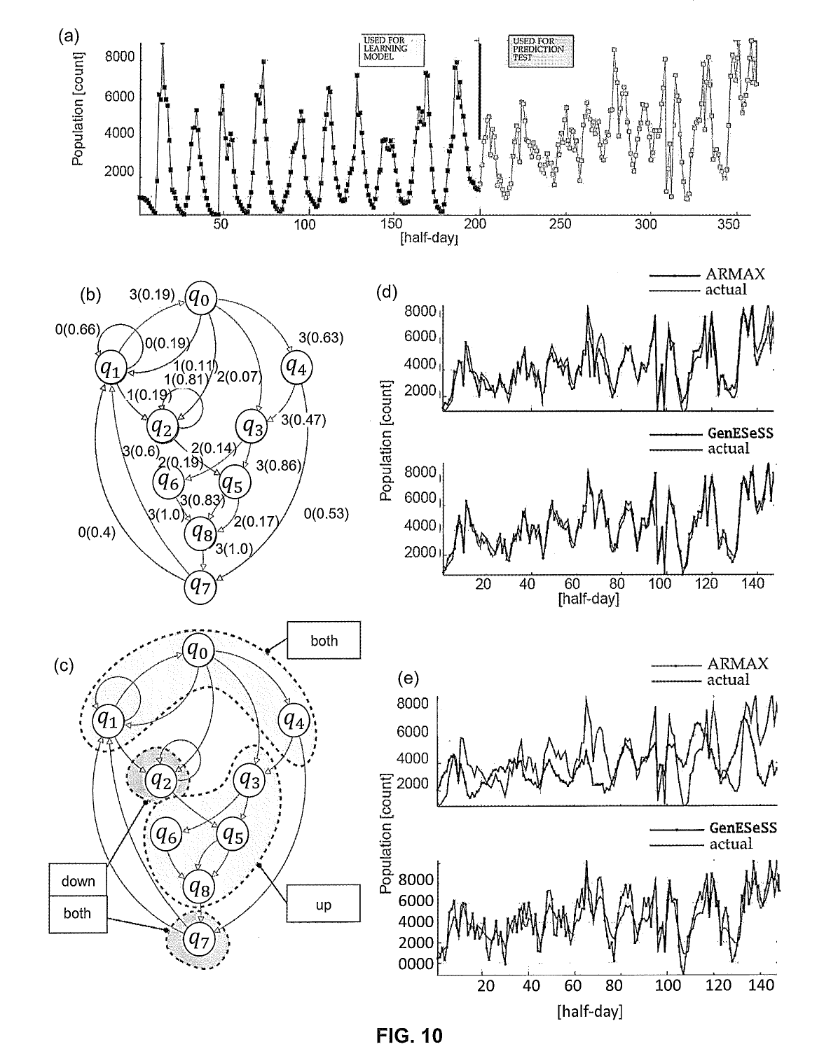

The inferred PFSAs are respectively illustrated in FIG. 9(b) and FIG. 10(b). The causal structure is simple for the photometric data, and significantly more complex for the population dynamics. For the photometric dataset, the states with only outgoing symbols 2, 3 (indicating a brightness increase next day), the states with outgoing symbols 1, 2 (indicating the possibility of either an increase or a decrease), and the states with outgoing symbols 2, 3 (indicating a decrease in intensity next day) are arranged in a simple succession FIG. 9(b). For the population dynamics, the group of states which indicate a predicted population increase in the next 12 h, the ones which indicate a decrease, and the ones which indicate either possibility have significantly more complex interconnections FIG. 10(c).

In both cases, ARMAX models are learned for comparison. ARMAX models include auto-regressive and moving average components, assume additive Gaussian noise, and linear dependence on history. ARMAX model order (p, q) is chosen to be the smallest value-pair providing an acceptable fit to the data (see Table 1), such that increasing the model order does not significantly improve prediction accuracy. The respective models with a portion of the time series are learned (FIG. 9(a) and FIG. 10(a)), and a comparison of the approaches with different prediction horizons (‘prediction horizon=1 day’ means ‘predict values 1 day ahead’) against the remaining part of the time series is made.

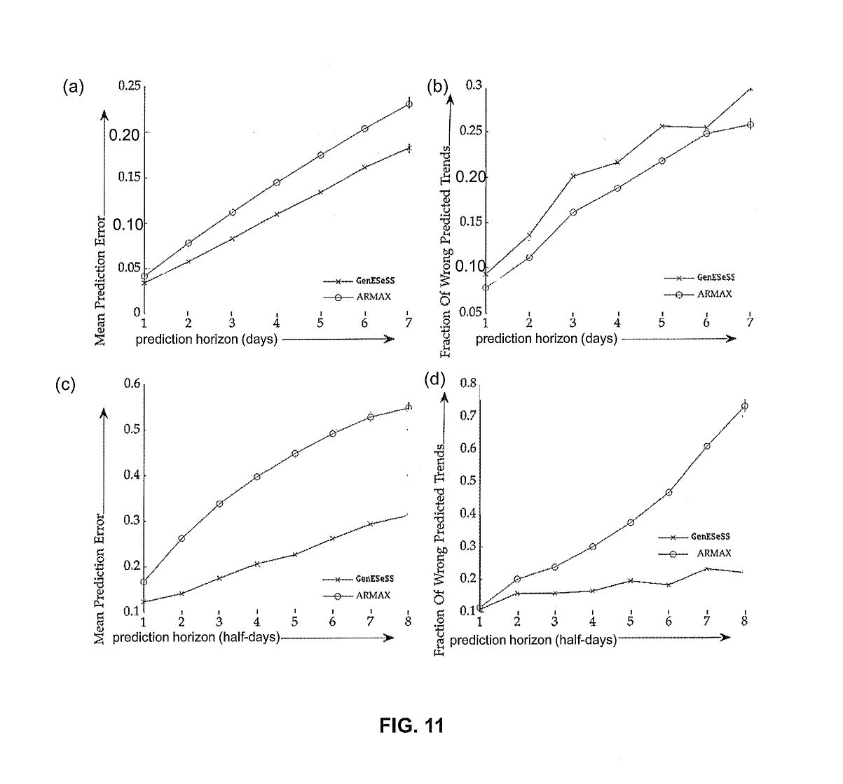

As illustrated, ARMAX does well in the first case, even for longer prediction horizons (see FIG. 9(c), (d)), but is unacceptably poor with the more involved population dynamics (see FIG. 10(d), (e)). Additionally, the ARMAX models do not offer clear insight into the causal structure of the processes as discussed above. FIG. 11(a),(c) plots the mean absolute prediction error percentage as a function of increasing prediction horizon for both approaches. For the photometric data, the error grows slowly, and is more or less comparable for ARMAX and GenESeSS. For the population data, GenESeSS does significantly better. Since continuous prediction series are generated from symbolic sequences using mean magnitudes (as described above; see also Table 1, column 4), GenESeSS is expected to better predict the sign of the gradient of the predicted data rather than the exact magnitudes.

In FIG. 11(b), (d) the percentage of wrongly predicted trends (i.e. percentage of sign mismatches) is plotted for the two cases. It should be noted that ARMAX is slightly better for the photometric data, while for the population data, GenESeSS is significantly superior (75% incorrect trends at a horizon of 8 days for ARMAX versus about 25% for GenESeSS). Thus, while for quasi-periodic data GenESeSS performance may be comparable to existing techniques, it is significantly superior in modelling and predicting complex stochastic dynamics.

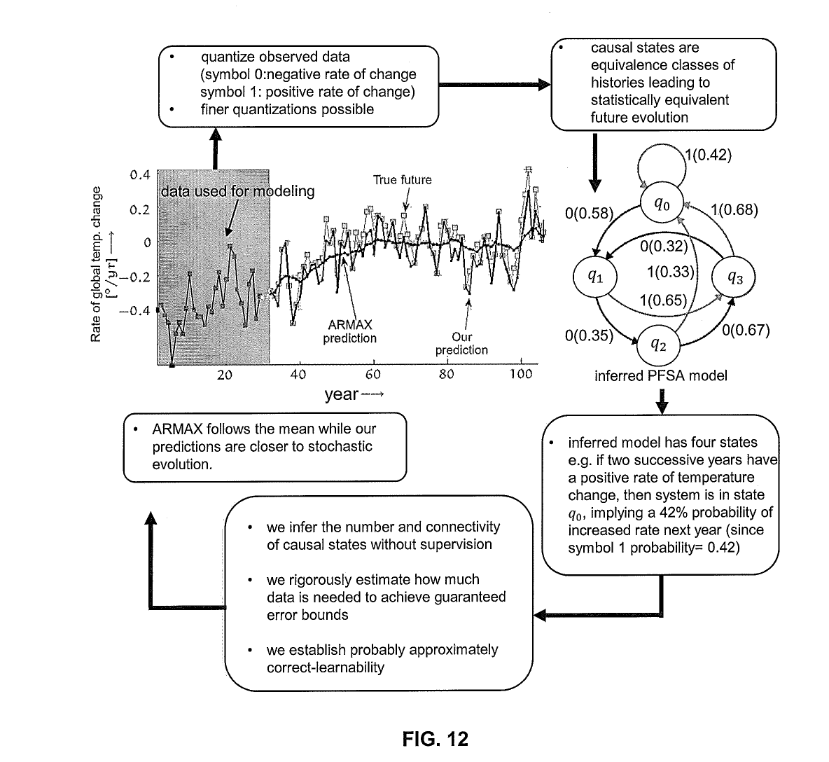

FIG. 12 is a conceptual diagram illustrating an example of inferring a probabilistic finite state automation using the techniques described herein. In the example illustrated in FIG. 12, global annual temperature changes from 1880 to 1986 are modeled. GenESeSS infers a 4-state PFSA; each state specifies the probabilities of positive (symbol 1) and negative (symbol 0) rate of change in the coming year. In this example, a binary alphabet, but finer quantizations may be used illustrated. Global temperature changes result from the complex interaction of many variables, and a first principle model is not deducible from this data alone; but causal states in the data can be inferred as equivalence classes of history fragments yielding statistically similar futures.

In some examples, the techniques described herein may be based on the following intuition: if the recent pattern of changes was encountered in the past, at least approximately, and then often led to a positive change in the immediate future, then a positive change in the immediate future is expected. Causal states simply formalize the different classes of patterns that need to be considered, and are inferred to specify which patterns are equivalent.

This allows quantitative predictions to be made. For example, state q₀ is the equivalence class of histories with last two consecutive years of increasing temperature change (two 1 s), and our inferred model indicates that this induces a 42 percent probability of a positive rate of change next year (that such a pattern indeed leads uniquely to a causal state is inferred from data, and not manually imposed). Additionally, the maximum deviation between the inferred and the true hidden model is limited by a user-selectable bound. For comparison, a standard auto-regressive moving-average (ARMAX) model is learned, which actually predicts the mean quite well. However, GenESeSS captures stochastic changes better, and gains deeper insight into the causal structure in terms of the number of equivalence classes of histories, their inter-relationships and model memory.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for inferring a probabilistic finite state automation, the method comprising:
receiving an observed string generated by a quantized stochastic process;
constructing a derivative heap using the observed string;
identifying a string mapping to a vertex of a convex hull of the derivative heap;
detecting a structure of a transition function for an inferred probabilistic finite state automation associated with the identified string; and
determining arc probabilities for the inferred probabilistic finite state automation associated with the identified string.

2. The method of claim 1, wherein constructing a derivative heap using the observed string includes selecting a subset set of strings.

3. The method of claim 1, wherein detecting a structure of a transition function for an inferred probabilistic finite state automation associated with the identified string includes associating a string identifier and a probability distribution on an alphabet.

4. The method of claim 1, wherein detecting a structure Of a transition function for an inferred probabilistic finite state automation associated with the identified string includes extending the structure recursively.

5. The method of claim 1, wherein determining arc probabilities for the inferred probabilistic finite state automation associated with the identified string includes choosing an arbitrary initial state.

6. The method of claim 5, wherein determining arc probabilities for the inferred probabilistic finite state automation associated with the identified string further includes running the observed string through the inferred probabilistic finite state automation.

7. A non-transitory computer-readable storage medium having instructions stored thereon that upon execution cause one or more processors of a device to:
receive an observed string generated by a quantized stochastic process;
construct a derivative heap using the observed string;
identify a string mapping to a vertex of a convex hull of the derivative heap;
detect a structure of a transition function for an inferred probabilistic finite state automation associated with the identified string; and
determine arc probabilities for the inferred probabilistic finite state automation associated with the identified string.

8. The non-transitory computer-readable storage medium of claim 7, wherein constructing a derivative heap using the observed string includes selecting a subset set of strings.

9. The non-transitory computer-readable storage medium of claim 7, wherein detecting a structure of a transition function for an inferred probabilistic finite state automation associated with the identified string includes associating a string identifier and a probability distribution on an alphabet.

10. The non-transitory computer-readable storage medium of claim 7, wherein detecting a structure of a transition function for an inferred probabilistic finite state automation associated with the identified string includes extending the structure recursively.

11. The non-transitory computer-readable storage medium of claim 7, wherein determining arc probabilities for the inferred probabilistic finite state automation associated with the identified string includes choosing an arbitrary initial state.

12. The non-transitory computer-readable storage medium of claim 11, wherein determining arc probabilities for the inferred probabilistic finite state automation associated with the identified string further includes running the observed string through the inferred probabilistic finite state automation.

13. A device for inferring a probabilistic finite state automation, the device comprising one or more processors configured to
receive an observed string generated by a quantized stochastic process;
construct a derivative heap using the observed string;
identify a string mapping to a vertex of a convex hull of the derivative heap;
detect a structure of a transition function for an inferred probabilistic finite state automation associated with the identified string; and
determine arc probabilities for the inferred probabilistic finite state automation associated with the identified string.

14. The device of claim 13, wherein constructing a derivative heap using the observed string includes selecting a subset set of strings.

15. The device of claim 13, wherein detecting a structure of a transition function for an inferred probabilistic finite state automation associated with the identified string includes associating a string identifier and a probability distribution on an alphabet.

16. The device of claim 13, wherein detecting a structure of a transition function for an inferred probabilistic finite state automation associated with the identified string includes extending the structure recursively.

17. The device of claim 13, wherein determining arc probabilities for the inferred probabilistic finite state automation associated with the identified string includes choosing an arbitrary initial state.

18. The device of claim 17, wherein determining arc probabilities for the inferred probabilistic finite state automation associated with the identified string further includes running the observed string through the inferred probabilistic finite state automation.

19. The device of claim 13, wherein the observed string generated by a quantized stochastic process is associated with climate data.

20. The device of claim 13, wherein the observed string generated by a quantized stochastic process is associated with biological data
